(19) United States
(12) Patent Application Publication
(10) Pub. No.: US 2012/0278553 A1
(43) Pub. Date: Nov. 1, 2012

(54) SYSTEM AND METHOD FOR MIGRATION OF DATA CLONES

(76) Inventors: Devender R. Mudhiganti, Bangalore (IN); Hirshikesh Keremane, Bangalore (IN); Somavarapu Nagender, Bangalore (IN); Tijin George, Bangalore (IN)

(21) Appl. No.: 13/096,619

(22) Filed: Apr. 28, 2011

(51) Int. Cl. G06F 12/02

(52) U.S. Cl. 711/114; 711/154; 711/E12.002

(57) ABSTRACT

Described herein is a system and method for migrating data from a source storage site to a destination storage site. The data may be comprised within storage objects (e.g., flexible volumes). A base storage object may comprise a parent storage object and a storage object clone may comprise a storage object that is derived from the base storage object. As such, a hierarchical relationship exists between the base storage object and the storage object clone. The storage object clone may comprise a writable point-in-time image of the parent storage object. If a migration of the base storage object and the storage object clone is performed, then the hierarchical relationship between the base storage object and the storage object clone is retained after the storage objects are migrated from the source storage site to the destination storage site. As such, the system and method for migrating data may enable storage space and network bandwidth savings.

### FIELD OF THE INVENTION

Embodiments of the present invention relate to storage systems, and in particular, to migration of data clones between storage systems.

### BACKGROUND

A storage system typically comprises one or more storage devices into which information may be entered, and from which information may be obtained, as desired. The storage system includes a storage operating system that functionally organizes the system by, inter alia, invoking storage operations in support of a storage service implemented by the system. The storage system may be implemented in accordance with a variety of storage architectures including, but not limited to, a network-attached storage environment, a storage area network and a disk assembly directly attached to a client or host computer. The storage devices are typically disk drives organized as a disk array, wherein the term “disk” commonly describes a self-contained rotating magnetic media storage device. The term disk in this context is synonymous with hard disk drive (HDD) or direct access storage device (DASD).

The storage operating system of the storage system may implement a high-level module, such as a file system, to logically organize the information stored on volumes as a hierarchical structure of storage objects, such as files and logical units (LUs). A known type of file system is a write-anywhere file system that does not overwrite data on disks. An example of a write-anywhere file system that is configured to operate on a storage system is the Write Anywhere File Layout (WAFL®) file system available from NetApp, Inc. Sunnyvale, Calif.

The storage system may be further configured to allow many servers to access storage objects stored on the storage system. In this model, the server may execute an application, such as a database application, that “connects” to the storage system over a computer network, such as a point-to-point link, shared local area network (LAN), wide area network (WAN), or virtual private network (VPN) implemented over a public network such as the Internet. Each server may request the data services of the storage system by issuing access requests (read/write requests) as file-based and block-based protocol messages (in the form of packets) to the system over the network.

A plurality of storage systems may be interconnected to provide a storage system architecture configured to service many servers. In some embodiments, the storage system architecture provides one or more aggregates, each aggregate comprising a set of one or more storage devices (e.g., disks). Each aggregate may store one or more storage objects, such as one or more volumes. The aggregates may be distributed across a plurality of storage systems interconnected as a cluster. The storage objects (e.g., volumes) may be configured to store content of storage objects, such as files and logical units, served by the cluster in response to multi-protocol data access requests issued by servers.

Each storage system(node) of the cluster may include (i) a storage server (referred to as a “D-blade”) adapted to service a particular aggregate or volume and (ii) a multi-protocol engine (referred to as an “N-blade”) adapted to redirect the data access requests to any storage server of the cluster. In the illustrative embodiment, the storage server of each storage system is embodied as a disk element (D-blade) and the multi-protocol engine is embodied as a network element (N-blade). The N-blade receives a multi-protocol data access request from a client, converts that access request into a cluster fabric (CF) message and redirects the message to an appropriate D-blade of the cluster.

The storage systems of the cluster may be configured to communicate with one another to act collectively to increase performance or to offset any single storage system failure within the cluster. The cluster provides data service to servers by providing access to a shared storage (comprising a set of storage devices). Typically, servers will connect with a storage system of the cluster for data-access sessions with the storage system. During a data-access session with a storage system, a server may submit access requests (read/write requests) that are received and performed by the storage system.

Each server may be within a specific storage site and each storage site may comprise multiple servers. Moreover, each server may execute numerous applications requiring the data services of the cluster. The data services of each server may be stored in data aggregates, such as flexible volumes. The data aggregates or flexible volumes may comprise a flexible volume hierarchy that may define a relationship between flexible volumes. For example, the flexible volume hierarchy may contain flexible volumes and clones of flexible volumes that relate to a base flexible volume.

Typically, a migration of the flexible volume hierarchy from a first storage site to a second storage site comprises a flattening or loss of the flexible volume hierarchical structure. For example, a clone of a flexible volume may be flattened or expanded such that when it is migrated to a second storage site. As such, after migration to the second storage site, further processing of the clone may be required, such as producing a copy of its base flexible volume and a delta or difference between the clone flexible volume and the base flexible volume (the clone then comprising the base flexible volume and the delta). As such, a migration of a flexible volume hierarchy from a first storage site to a second storage site may utilize additional processing and storage resources.

As such, conventional data migration techniques of a flexible volume hierarchy do not preserve the relationship between a base flexible volume and any clones of the base flexible volume. Thus, an effective method and system for allowing migration of data clones and the retention of the data clone hierarchy from a first storage site to a second storage site is needed.

### SUMMARY

The embodiments described herein provide a system and method for migration of data from a first source storage system to a second destination storage system. In some embodiments, a data clone migration manager is configured for receiving hierarchical storage object data that describes a relationship between a first storage object and a first clone of the first storage object. The hierarchical storage object data indicates that the first clone is derived from the first source storage object and comprises a pointer to an image of the first source storage object. The first storage object and the first clone may be stored on the source storage system. A first destination storage object is provisioned on the destination storage system. Data from the first storage object on the source storage system is transferred to the first destination storage object on the destination storage system. The transferring of the data may comprise writing the data of the first source storage object on the source storage system to at least one storage device on the destination storage system. A second destination storage object is provisioned on the destination storage system. The second destination storage object may be configured to store a pointer to the data of the first destination storage object on the destination storage system.

In some embodiments, the image of the first source volume is produced at a first time point and the first clone is produced at a second time pointer after the first time point. A delta data of the first clone may be stored in the source storage system and may comprise changes to the first source storage object between the first time point when the first image is generated and the second time point when the first clone is produced. The data clone migration manager engine may further transfer the delta data of the first clone from the source storage system to the second destination storage object on the destination storage system.

In some embodiments, the storage object may comprise a flexible volume comprising data distributed over a plurality of storage devices. A data clone migration manager engine is configured for receiving flexible volume hierarchical storage volume data (herein referred to as “hierarchical data”) regarding storage volumes. The hierarchical data comprises a relationship between a source flexible volume and a clone of the source flexible volume. The clone of the source flexible volume may be derived from the source flexible volume. A destination flexible volume is provisioned on the destination storage system and the data comprised within the source flexible volume is migrated or written to the provisioned source flexible volume on the destination storage system. A second destination flexible volume is provisioned on the destination storage system. A delta, or difference in data between the source flexible volume and the clone of the source flexible volume, is then migrated or written to the second destination flexible volume.

In some embodiments, hierarchical storage object data comprises a storage object type, parent object and derived clones of the first source storage object and the first clone. The storage object type may specify whether the storage object comprises a base storage object or a clone. The parent object specifies the storage object that the clone of the first source storage object is derived from and the derived clones may specify clones derived from the first source storage object and the first clone.

In some embodiments, the hierarchical storage object data may further describe a relationship between the first clone and a second clone that comprises a clone of the first clone. The hierarchical storage object data indicates that the second clone is derived from the first clone and comprises a pointer to an image of the first clone. The second clone may be stored in the source storage system. The data clone migration manager engine may be further configured to provision a third destination storage object on the destination storage system and to configure the third destination storage object to store a pointer to the image of the first clone on the destination storage system.

In further embodiments, a roll back of the first destination storage object and the second destination storage object on the destination storage system may be performed. The roll back may comprise removing the first destination storage object and the second destination storage object on the destination storage system and a restoration of the first source storage object and the first clone on the source storage system. The relationship between the first source storage object and the first clone may be retained on the source storage system.

As such, the migration method presents several advantages for a storage system environment. For example, the retention of the storage object hierarchy after migration may result in the reduced use of storage resources and the ability of an administrator or user to roll back the migration of the storage object hierarchy from the second storage site to the first storage site. As such, storage space and network bandwidth savings may be realized with the utilization of the migration method.

### BRIEF DESCRIPTION OF THE DRAWINGS

FIG. 1 is a schematic diagram of an exemplary distributed storage system environment in which some embodiments operate.

FIG. 2 is a block diagram of an exemplary virtual server environment in which some embodiments operate.

FIG. 3 is a schematic block diagram of an exemplary cluster storage system environment in which some embodiments operate.

FIG. 4 is a schematic block diagram of an exemplary management server that may be employed in the cluster storage system environment.

FIG. 5 is a schematic block diagram of an embodiment of an aggregate (system or data aggregate) that may be used in some embodiments.

FIG. 6 is a schematic block diagram of an exemplary migration of data clones from a first storage site to a second storage site.

FIG. 7 is a flowchart of a method for the migration of a flexible volume clone hierarchy from a first storage site to a second storage site in accordance with some embodiments.

FIG. 8 is a flowchart of a method for the provisioning of a flexible volume clone hierarchy from a first storage site to a second storage site in accordance with some embodiments.

FIG. 9 is an exemplary data clone hierarchy migration management data structure used in some embodiments.

FIG. 10 is a flowchart of a method for the migrating of a flexible volume clone hierarchy from a source storage site to a destination storage site and a rollback and retry of the migration.

### DETAILED DESCRIPTION

In the following description, numerous details and alternatives are set forth for purpose of explanation. However, one of ordinary skill in the art will realize that embodiments can be practiced without the use of these specific details. In other instances, well-known structures and devices are shown in block diagram form to not obscure the embodiments with unnecessary detail.

The description that follows is divided into three sections. Section I contains terms used herein. Section II describes a cluster storage system environment in which some embodiments operate. Section III describes a system and method for migrating data clones between storage systems

### I. Terms

Storage object: As used herein, a storage object comprises any type of container for storing data. Examples of storage objects include, but are not limited to, files, LUs, qtrees, volumes, flexible volumes, aggregates, storage devices, etc. For illustrative purposes, the embodiments below are described in relation to a flexible volume, e.g., base flexible volume, flexible volume clone, flexible volume clone hierarchy, etc. However, in other embodiments, any other type of storage object may be used in the embodiments below.

Clone: As used herein, a clone may comprise an instant replication of a storage object without requiring additional storage space at the time of creation. A clone of a storage object may comprise a transparent virtual copy of data of the storage object and does not require any copying of data. A clone of a storage object is derived from and based on the storage object. For example, the clone may comprise a virtual image of the storage object, a pointer to the storage object, or a pointer to an image of the storage object. For example, the clone may comprise a virtual image or a pointer to the base storage object. As such, a clone may comprise a virtual container that may be provisioned, sized, and resized dynamically to simplify operations. However, incremental storage capacity is only needed for clone-specific metadata and non-redundant data blocks. In some embodiments, the clone stores data comprising changes between the base storage object and the clone. When a clone is created, it uses the base storage object and/or a snapshot image of the base storage object to use as its base. For example, a clone may comprise a pointer to an image of a storage object and a delta data, whereby the image is produced at a first time point and the clone is produced at a second time point after the first time point. The delta data of the clone may comprise changes to the storage object between the first time point and the second time point. The clone receives a copy of the snapshot image metadata and then updates its metadata as the clone is written. The common snapshot between the base storage object and the clone is read only and may be reused as the base for multiple clones. Thus, storage device space is saved because new device space used is associated with small amounts of metadata or meaningful changes to either the base storage object or the clone. Thus, the clone may comprise a writeable point-in-time image of a base storage object or even of another clone of a base storage object. As such, clones add a new level of agility and efficiency to storage operations. For illustrative purposes, the embodiments below are described in relation to a flexible volume clone. However, in other embodiments, any other type of clone may be used in the embodiments below.

Cluster storage system: As used herein, a cluster storage system may comprise a set of one or more storage systems. In some embodiments, the cluster may comprise one storage system. As such, the terms “cluster” and “storage system” may sometimes be used interchangeably. In other embodiments, a cluster comprises a plurality of storage systems.

Flexible volume: As used herein, a flexible volume may comprise a type of storage volume that may be efficiently distributed across a plurality of storage devices and may be resized to meet changing business or application requirements. In some embodiments, a storage system may provide one or more aggregates and one or more storage volumes distributed across a plurality of nodes interconnected as a cluster. Each of the storage volumes may be configured to store data such as files and logical units. As such, in some embodiments, a flexible volume may be comprised within a storage aggregate and further comprises at least one storage device. The storage aggregate may be abstracted over a RAID plex where each plex comprises a RAID group. Moreover, each RAID group may comprise a plurality of storage disks. As such, a flexible volume may comprise data storage spread over multiple storage disks or devices.

Base flexible volume: As used herein, a base flexible volume comprises a volume that is not a clone of a flexible volume. For example, a base flexible volume may be a flexible volume that has been cloned. As such, a base flexible volume may be considered to be a base volume that is depended upon by at least one flexible volume clone. The flexible volume clone may be considered to be a child flexible volume.

Snapshot: As used herein, a snapshot comprises a feature that creates an online, read-only copy of a file system. The snapshot may protect against accidental deletions or modifications of files without duplicating file contents. In some embodiments, a snapshot is utilized by a flexible volume clone to create a point in time view or image of a base flexible volume. When a file is changed, the snapshot copy (or resulting flexible volume clone)may still point to the storage device blocks where the file existed before it was modified and changes are written to new storage device blocks. As data is changed in the base flexible volume, the original data blocks stay associated with the snapshot copy rather than getting marked for reuse.

Storage object clone hierarchy: As used herein, a storage object clone hierarchy comprises a definition of a relationship between various base storage objects and their corresponding clones. Storage object clone hierarchy data may comprise data that describes/indicates the hierarchical relationship of base storage objects and their clones. For example, flexible volume clone hierarchy may comprise a definition of a relationship between various base flexible volumes and flexible volume clones. For example, the flexible volume hierarchy may comprise information that details the hierarchical relationship of base flexible volumes and flexible volume clones. As such, the flexible volume hierarchy is the relationship between base flexible volumes and flexible volume clones. For illustrative purposes, the embodiments below are described in relation to a flexible volume clone hierarchy. However, in other embodiments, any other type of storage object other than a flexible volume may be used in the embodiments below.

Delta data: As used herein, delta data comprises a difference between the base flexible volume and its flexible volume clone. For example, a flexible volume clone delta may comprise changes or differences between the base flexible volume and the flexible volume clone that have been stored or written to new storage device blocks.

Data clone migration manager engine: As used herein, a data clone migration manager engine may reside on a management server and be used for migrating data clones or flexible volume hierarchical structure from a first storage site to a second storage site. The data clone migration manager engine may sometimes be referred to as a central service engine.

### II. Cluster Storage System Environment

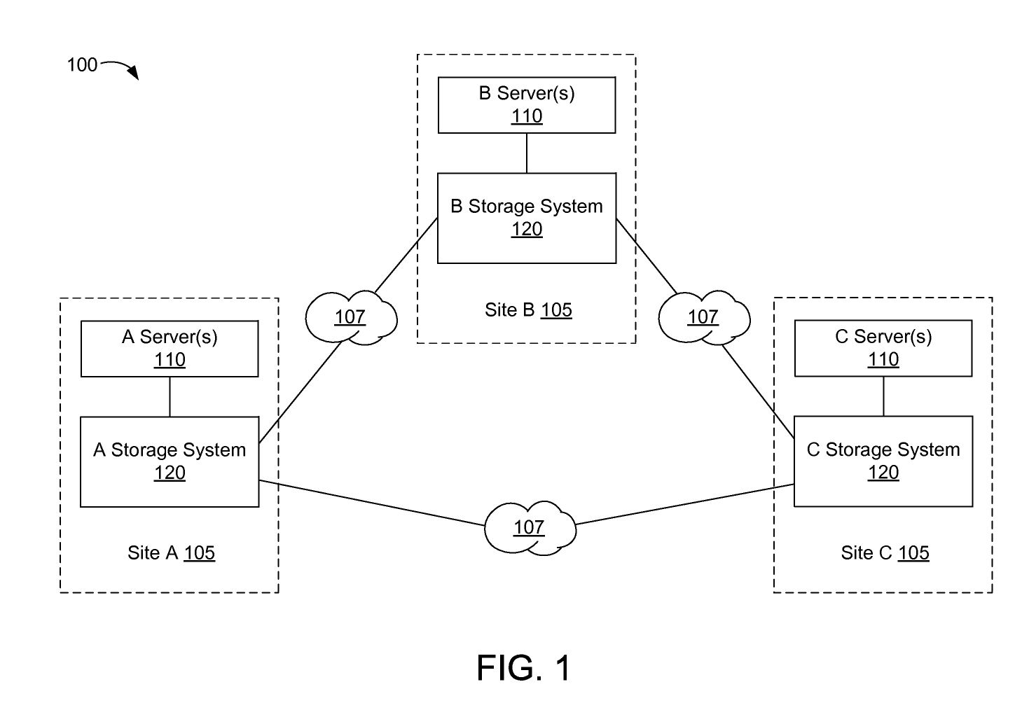

FIG. 1 is a schematic diagram of an exemplary distributed storage system environment 120 in which some embodiments operate. The environment 120 comprises a set of sites 105 (e.g., sites A, B, C) connected by a connection system 107. Each site 105 comprises a set of server systems 110 and a storage system 120. As such, each site 105 may comprise a separate cluster storage system environment. The connection system 107 may comprise a network, such as a Local Area Network (LAN), Wide Area Network (WAN), metropolitan area network (MAN), the Internet, or any other type of network or communication system between computer systems. In some embodiments, each site 105 may be located, for example, at great distances from each other and in different geographic regions (e.g., in different states, countries, etc.).

In these embodiments, the connection system 107 may comprise, for example, a WAN or the Internet. The various sites 105 may be connected with each other through the storage systems 120 of the various sites 105, whereby a storage system 120 of a site 105 is connected with each storage system 120 of each of the other sites 105. The storage systems 120 may communicate directly with each other to receive and send access requests between the storage systems 120. The storage systems 120 may be considered peers in terms of network connectivity. In some embodiments, each storage system 120 may be identified by a unique identifier to distinguish each storage system 120 on the connection system 107. For example, each storage system 120 may be identified by an Internet Protocol (IP) address or domain name associated with the storage system 120 to locate the storage system 120 within a network. In the below embodiments, the unique identifiers of the storage systems 120 may be used, for example, to identify which storage systems 120 have particular delegations, which storage system 120 is a current owner of the origin shared data set, which storage system 120 is a new owner of the origin shared data set, etc.

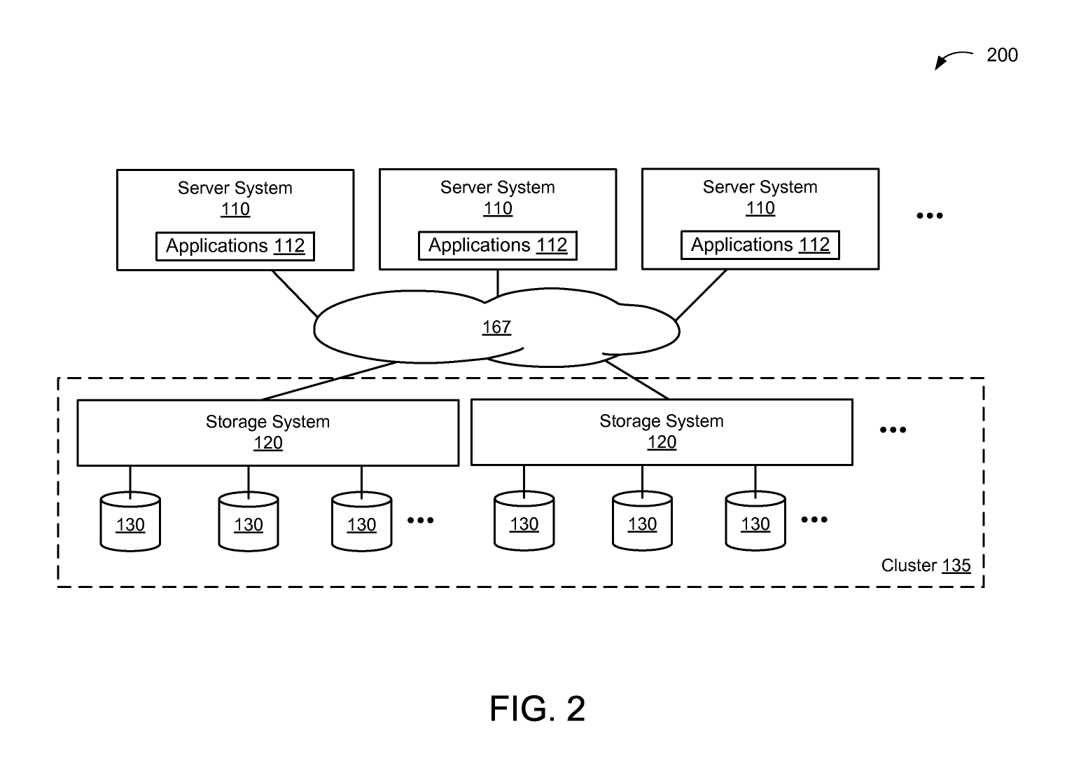

FIG. 2 is a block diagram of an exemplary virtual server environment 200 in which some embodiments operate. The environment 200 may comprises a set of one or more server systems and one or more storage systems 120. The server systems 110 may each access one or more storage systems 120 that are connected to the server systems 110 via a network 167. The one or more storage systems 120 comprise a cluster storage system 135. Each storage system 120 in the cluster 135 may comprise a set of storage devices 130 for storing client data, the storage devices 130 of the cluster 135 comprising a shared storage of the storage system 120. Note that the server systems 110 are also connected to each other (e.g., via network 167) for communicating with each other (e.g., for working collectively to provide data-access service to a user/client system (not shown) for collectively hosting a plurality of virtual machines as described herein).

A server system 110 may comprise a computer system that may execute one or more applications 112 that interacts with the storage systems 120 for receiving read/write access requests and receiving or transmitting data over the network 167. In some embodiments, a server system 110 may comprise a chassis hosting multiple instances of server systems 110, each server system 110 hosting multiple client systems embodied as virtual machines. The network 167 and/or subnets of networks 167 may be physically embodied within such a chassis.

An application 112 executing on a server system 110 may provide data-access services by transmitting and processing access requests for data from the storage system(s) 120. In turn, an application 112 utilizes the services of the storage system 120 to access, store, and manage data in a set of storage devices 130. As such, a server system 110 may execute one or more applications 112 that submit access requests for accessing particular storage objects on the storage devices. Each application 112 may submit access requests for accessing particular storage objects on the storage systems of the cluster 135 and the cluster 135 may perform the received requests on the storage objects. An application 112 may comprises a non-virtual based application, such as a typical email exchange application or database application. In other embodiments, an application 112 may comprise a virtual-based application, such as a virtual machine (discussed below).

A storage system 120 may be coupled locally to a server system 110 over a network 167 such as a local area network (LAN), an Ethernet subnet, a PCI or PCIe subnet, a switched PCIe subnet, a wide area network (WAN), a metropolitan area network (MAN), the Internet, or the like. In some embodiments, a server system 110 may comprise a chassis hosting multiple instances of server systems 110 within a single chassis (e.g., a blade server chassis), with each instance of a server system 110 in communication with each other instance of a server system 110 in the chassis via network 167.

Interaction between the server systems 110 and the storage system(s) 120 can enable the provision of storage services. That is, the server systems 110 may request the services of the storage system(s) 120 (by submitting read/write access requests), and the storage system(s) 120 may respond to read/write access requests of the server systems 110 by receiving or transmitting data to the server systems 110 over the network 167 (e.g., by exchanging data packets through a connection over the network 167).

Communications between a storage system 120 and any of server systems 110 are typically embodied as packets sent over the computer network 167. A server system 110 may send an access request (a read/write access request) to the storage system 120 for accessing particular data stored on the storage system. The server system 110 may request the services of the storage system 120 by issuing storage-access protocol messages formatted in accordance with a conventional storage-access protocol for accessing storage devices (such as CIFS, NFS, etc.). Access requests (e.g., read/write access requests) may be implemented by issuing packets using file-based access protocols—such as the Common Internet File System (CIFS) protocol or Network File System (NFS) protocol—over the Transmission Control Protocol/Internet Protocol (TCP/IP) when accessing data in the form of files and directories. Alternatively, the server system 110 may issue access requests by issuing packets using block-based access protocols—such as the Fibre Channel Protocol (FCP), or Internet Small Computer System Interface (iSCSI) Storage Area Network (SAN) access—when accessing data in the form of blocks.

Each application 112 executing on a server system 110 may utilize services of the cluster 135 to store and access its data. The storage system 120 may comprise a computer system that stores data in a set of one or more storage devices 130 as storage objects. A storage device 130 may comprise writable storage device media such as storage devices, video tape, optical devices, DVD, magnetic tape, flash memory, Magnetic Random Access Memory (MRAM), Phase Change RAM (PRAM), or any other similar media adapted to store information (including data and parity information).

As known in the art, a storage device 130 may comprise storage objects comprising one or more storage volumes, where each volume has a file system implemented on the volume. A file system implemented on the storage devices 130 may provide multiple directories in a single volume, each directory containing zero or more filenames. A file system provides a logical representation of how data (files) are organized on a volume where data (files) are represented as filenames that are organized into one or more directories. Examples of common file systems include New Technology File System (NTFS), File Allocation Table (FAT), Hierarchical File System (HFS), Universal Storage Device Format (UDF), UNIX® file system, and the like. For the Data ONTAP® storage operating system (available from NetApp, Inc. of Sunnyvale, Calif.) which may implement a Write Anywhere File Layout (WAFL®) file system, there is typically a WAFL file system within each volume, and within a WAFL file system, there may be one or more logical units (LUs).

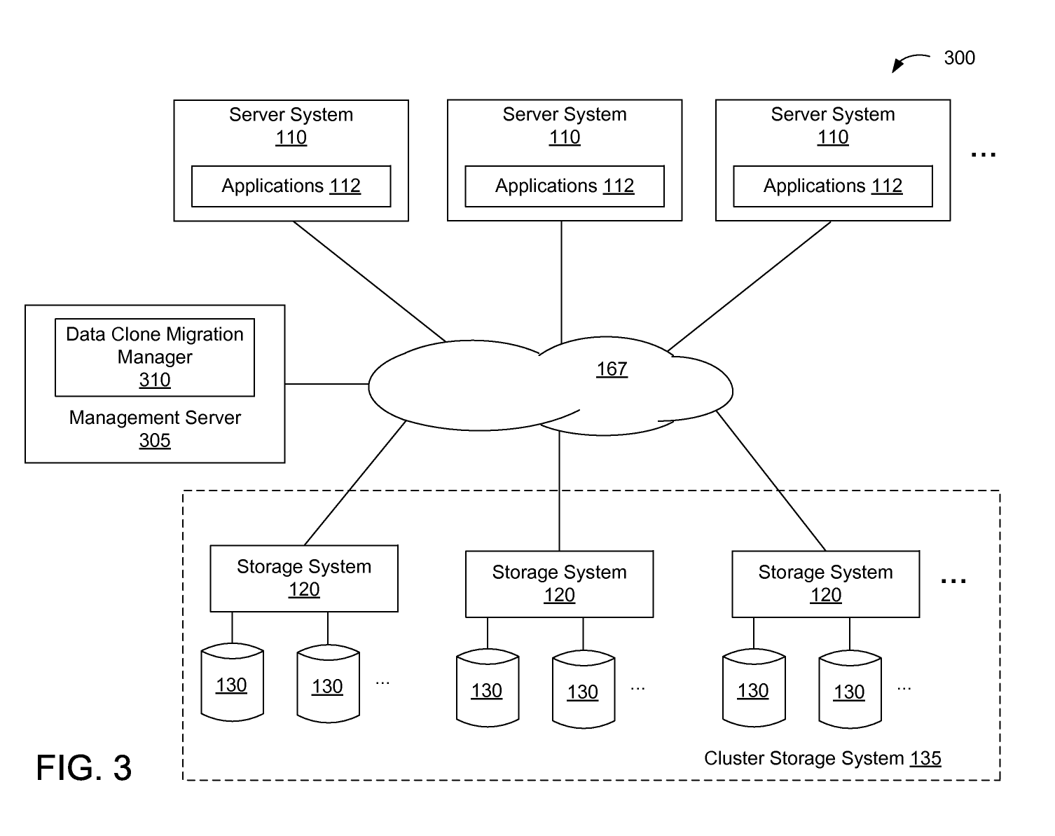

FIG. 3 is a schematic block diagram of an exemplary cluster storage system environment 300 in which some embodiments operate. The environment 300 comprises a set of one or more server systems 110, a cluster 235 comprising a set of one or more storage systems 120, and a management server 305 that are connected via a connection system 167. In other embodiments, the cluster 135 comprises a plurality of storage systems 120. Each storage system 120 comprises a set of one or more storage devices 130. The connection system 167 may comprise a network, such as a Local Area Network (LAN), Wide Area Network (WAN), metropolitan area network (MAN), the Internet, or any other type of network or communication system between computer systems.

Each storage system 120 may have a distributed architecture. For example, each storage system 120 may include separate N module (network module) and D module (data module) components (not shown). In such an embodiment, the N module is used to communicate with the server systems 110, while the D module includes the file system functionality and is used to communicate with the storage devices 130. In another embodiment, the storage server 108 may have an integrated architecture, where the network and data components are all contained in a single box or unit. The storage system 120 may be coupled through a switching fabric (not shown) to other storage systems 120 in the cluster 135. In this way, all the storage systems 120 of the cluster 135 may be interconnect to form a single storage pool that may be accessed by the connected server systems 110.

The storage systems 120 comprise functional components that cooperate to provide a distributed storage system architecture providing consolidated data services to the server systems 110. A server system 110 may comprise a computer system that utilizes services of the cluster storage system 135 to store and manage data in the storage devices 130 of the storage systems 120. Interaction between a server system 110 and a storage system 120 can enable the provision of storage services. That is, server system 110 may request the services of the storage system 120, and the storage system 120 may return the results of the services requested by the server system 110, by exchanging packets over the connection system 167. The server system 110 may request the services of the storage system by issuing packets using file-based access protocols, such as the Common Internet File System (CIFS) protocol or Network File System (NFS) protocol, over the Transmission Control Protocol/Internet Protocol (TCP/IP) when accessing information in the form of files and directories. Alternatively, the server system 110 may issue packets including block-based access protocols, such as the Fibre Channel Protocol (FCP), or Internet Small Computer System Interface (iSCSI) Storage Area Network (SAN) access, when accessing information in the form of blocks.

The storage system 120 may comprise a computer system that stores data in a set of storage devices 130, preferably on one or more writable storage device media (such as magnetic storage devices, video tape, optical, DVD, magnetic tape, and any other similar media adapted to store information, including data and parity information). The storage system 120 may implement a file system to logically organize the data as storage objects on the storage devices 130. A storage system 120 or a server system 110 may execute one or more applications 112 that submit access requests for accessing particular storage objects on the storage devices 130.

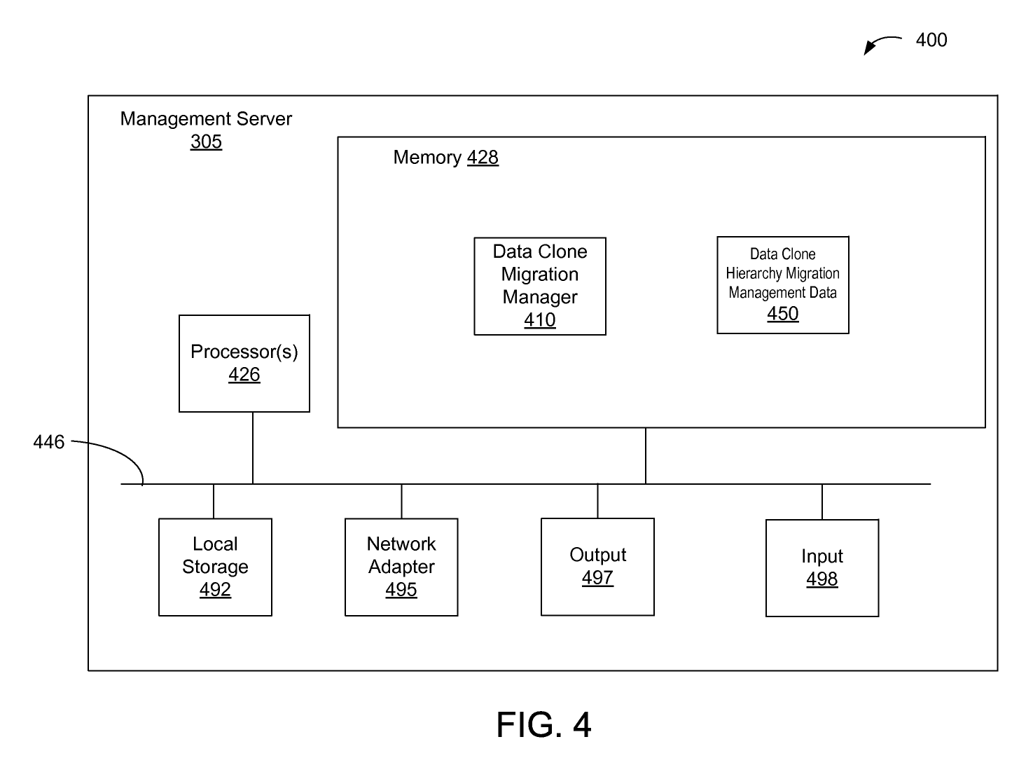

FIG. 4 is a schematic block diagram 400 of an exemplary management server 305 that may be employed in the cluster storage system environment of FIG. 3. The management server 305 comprises server processor(s) 426, server memory 428, a server local storage 492, a server network adapter 495, an output component 497, and an input component 498 coupled by a bus 1346.

The server processors 426 are the central processing units (CPUs) of the management server 305 and, thus, control the overall operation of the management server 305. Server processors 426 may include one or more programmable general-purpose or special-purpose microprocessors, digital signal processors (DSPs), programmable controllers, application specific integrated circuits (ASICs), programmable logic devices (PLDs), or the like, or a combination of such devices. The server network adapter 495 comprises a plurality of ports adapted to couple the management server 305 to one or more other computer systems (such as servers 110 or storage systems 100) over point-to-point links, wide area networks, virtual private networks implemented over a public network (Internet) or a shared local area network. The server network adapter 495 thus may comprise the mechanical, electrical and signaling circuitry needed to connect the storage system to the network.

The output component 497 may be of any type generally used by a computer system to provide information to an end user (e.g., administrator). For example, the output component 497 could include a monitor, an audio speaker, or an alphanumeric display. Similarly, the input component 498 may be of any type that allows an end user to provide input into a computer system. For example, the input component 498 may be a keyboard, a mouse, or a speech recognition system. In some embodiments, the input component 498 may be used by an administrator inputting policy information or grouping datasets.

Server memory 428 can be a random access memory (RAM), a read-only memory (ROM), or the like, or a combination of such devices. It will be apparent to those skilled in the art that other processing and memory means, including various computer readable media, may be used for storing and executing program instructions pertaining to the embodiments described herein. Server memory 428 comprises storage locations that are addressable by the processor 426 and adapters for storing software program code, such as software described herein. The server processor 426 and server adapters may, in turn, comprise processing elements and/or logic circuitry configured to execute the software code. Such software code may include a data clone migration manager 410 and a data clone hierarchy migration management data structure 450. In some embodiments, the various modules may configure hardware components of the management server to produce a data clone migration manager 410 and a data clone hierarchy migration management data structure 450.

Server local storage 492 is a storage device that stores data needed by the data clone migration manager module 410 and data clone hierarchy migration data structure 450 for performing the embodiments described herein. Such data may include all storage volumes, storage volume types, parent volumes, and clone volumes. The management server 305 loads data stored on the server local storage 492 into server memory 428 from which they are accessed by server processors 426. The server local storage 492 may also store data produced by the data clone migration manager module 410 and data clone hierarchy migration data structure 450 upon performing the embodiments described herein. For example, such data may include the hierarchical relationships between base volumes and any clone volumes based on a base volume.

In some embodiments, data clone migration manager module 410 and data clone hierarchy migration data structure 450 for performing the embodiments described herein reside and execute on the management server 305 which is external and separate from the server 110 and storage systems 100. In other embodiments, the data clone migration manager module 410 and data clone hierarchy migration data structure 450 may be distributed and reside and execute on one or more servers 110 and/or one or more storage systems 100.

The data clone migration manager module 410 may be configured to perform the migration of the flexible volume clones between storage systems. In some embodiments, the data clone migration manager module 410 may receive information about base volumes, flexible volumes, and flexible volume clones. The data clone migration manager module 410 may migrate and provision base volumes and flexible volume clones on the destination storage system based on the received information. The received information and the datasets may be stored into a data structure. The data clone migration manager module 410 may assign a policy to each dataset and implement the policy on each application object of each dataset and each underlying storage object of each application object.

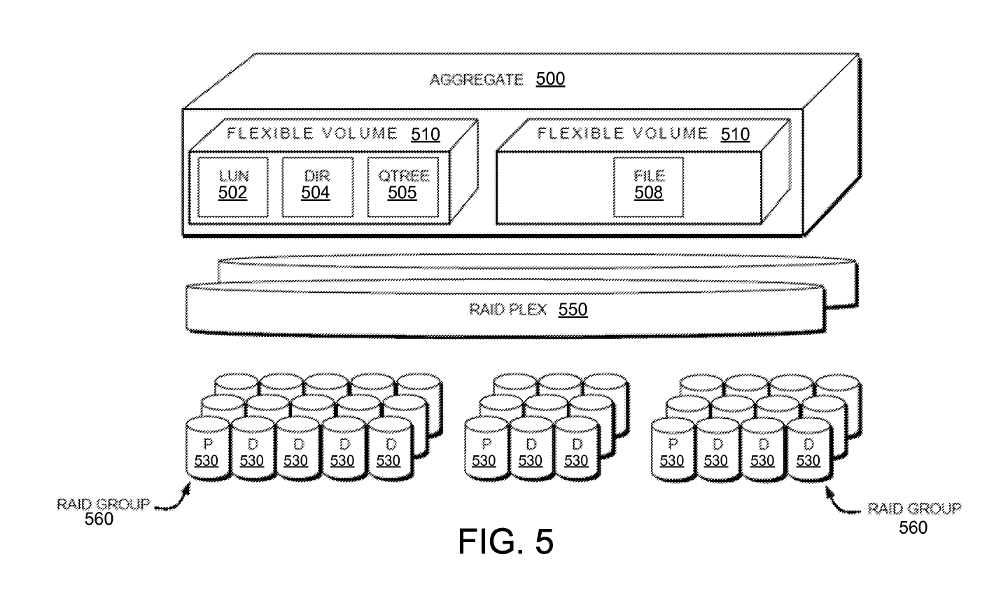

FIG. 5 is a schematic block diagram of an embodiment of an aggregate 500 (system or data aggregate) that may be used in some embodiments. The total storage space of an aggregate 500 may be allocated among a set of one or more flexible volumes 510. A flexible volume 510 may be dynamically increased or decreased in storage size within the total storage space of the aggregate 500. Each flexible volume 510 may comprise one or more storage objects, such as, Luns (blocks) 502, directors 504, qtrees 506, files 508, etc. The aggregate 500 is illustratively layered on top of a RAID system, which is represented by at least one RAID plex 550 (depending upon whether the storage configuration is mirrored), wherein each RAID plex 550 comprises at least one RAID group 550. Each RAID group 550 further comprises a plurality of storage disks 630, e.g., one or more data disks and at least one parity disk.

### III. Migrating Data Clones Between Storage Systems

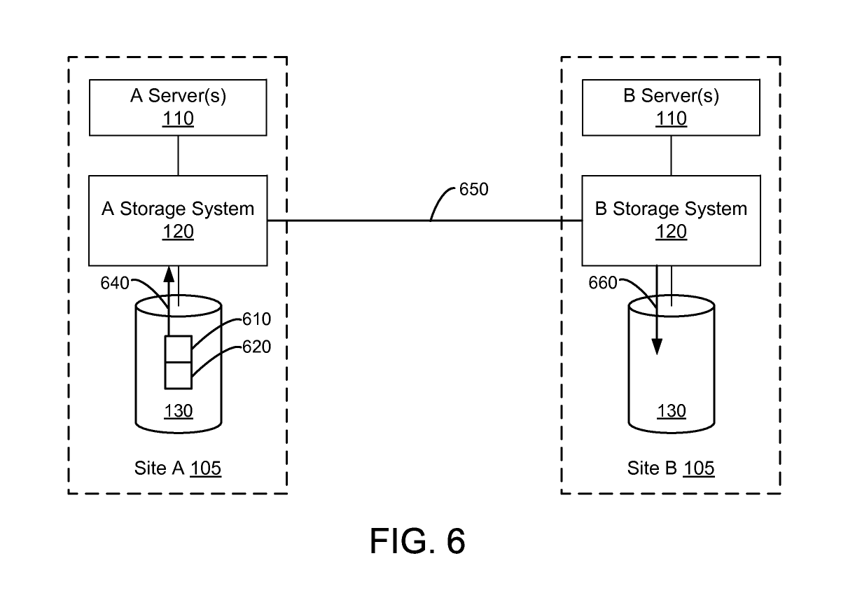

FIG. 6 is a schematic block diagram 600 of an exemplary migration of data clones from a first storage site to a second storage site. The storage site A (105) comprises a server system 110, storage system 120, and at least one storage device 670. In some embodiments, the storage site A may comprise a plurality of storage devices 670. Similarly, the storage site B comprises a server system 110, storage system 120, and at least one storage device 130. Moreover, in some embodiments, the storage site B may also comprise a plurality of storage devices 670. In some embodiments, each of the storage sites A and B may comprise a plurality of storage devices 670, arranged in a RAID fashion as previously described with respect to FIG. 5, and storage site A comprising a flexible volume or flexible volume clone for migrating to storage site B.

As seen in FIG. 6, storage device 670 of site A comprises a flexible volume 610. The flexible volume 610 is a base flexible volume and as such does not depend on another flexible volume. The storage device 670 of storage site A further comprises a flexible volume clone 620 that may be a clone of the flexible volume 610. As such, flexible volume 610 is the parent volume for flexible volume clone 620. As previously discussed, a flexible volume clone 620 may comprise a writable point-in-time image of a base flexible volume and comprises a delta flexible volume portion for storing space to hold any desired changes to the base flexible volume clone. As such, in some embodiments, the flexible volume clone 620 comprises a writable point-in-time image of the base flexible volume 610 with a delta flexible volume clone portion that stores any desired changes to the base flexible volume clone 610.

As a result, in some embodiments, the flexible volume clone hierarchy of storage site A (105) comprises a base flexible volume in flexible volume 610 and the flexible volume clone 620. However, since the flexible volume clone 620 comprises a writable point-in-time image of the flexible volume 610 with a delta flexible volume clone portion, the utilization of additional storage resources is minimal. For example, the flexible volume 610 may comprise a 10 terabyte storage volume of data. The flexible volume clone 620 may comprise a clone of the flexible volume 610. As such, the flexible volume clone 620 comprises a writable point-in-time image of the existing 10 terabyte storage volume that does not utilize additional storage space and further comprises a delta flexible volume clone portion that stores any desired changes to the base flexible volume 610 of the flexible volume clone 620. For example, if the desired changes to the base flexible volume 610 comprise 1 terabyte of data, then the total flexible volume clone hierarchy comprising the base flexible volume 610 and the flexible volume clone 620 may comprise a total of 11 terabytes of storage space. However, if the flexible volume clone hierarchy was not retained or was flattened, then the storage space utilization would comprise 10 terabytes for the base flexible volume 610, an additional 10 terabytes for a copy of the base flexible volume 610 for the flexible volume clone 620, and an additional 1 terabyte for the desired changes to the base flexible volume 610 (e.g., the delta portion of the flexible volume clone) for a total storage space utilization of 21 terabytes. As a result, the flexible volume clone hierarchy presents a small amount of storage overhead.

In some embodiments, the flexible volume clone hierarchy may be configured to migrate flexible volumes and flexible volume clones from a storage site A to a storage site B. For example, an administrator or user may wish to improve resource utilization by migrating storage data to a less powerful storage system configuration. The storage data may be migrated from a high-end storage system to a low-end storage system or from a low-end storage system to a high-end storage system. In the same or alternative embodiments, an administrator or user may wish to migrate storage data from a faster storage device type comprised within a storage site to a slower storage device type comprises within a second storage site. As such, an administrator or user may wish to migrate a flexible volume clone hierarchy from a high end storage platform to a lower end storage platform while retaining the flexible volume clone hierarchy during the migration from the high end storage platform to the lower end storage platform. Similarly, the administrator or user may wish to migrate a flexible volume clone hierarchy from a low end storage platform to a high end storage platform while retaining the flexible volume clone hierarchy during the migration from the low end storage platform to the high end storage platform. In the same or alternative embodiments, an administrator or user may wish to migrate a flexible volume clone hierarchy from a storage site comprising a faster storage device to a storage site comprising a slower storage device while retaining the flexible volume clone hierarchy. Similarly, the administrator or user may wish to migrate the flexible volume clone hierarchy from a storage site comprising a slower storage device to a storage site comprising a faster storage device.

As such, an administrator or user may desire to migrate the flexible volume 610 and the associated flexible volume clone 620 from storage site A to storage site B. As discussed above, if the base flexible volume 610 comprises 10 terabytes of storage space and the delta flexible volume portion of the flexible volume clone 620 comprises 1 terabyte of storage space, then the total flexible volume clone hierarchy may comprise a total of 11 terabytes of storage space. As such, if the flexible volume 610 and the flexible volume clone 620 are migrated from storage site A to storage site B and the flexible volume clone hierarchy as defined in storage site A is retained at storage site B, then the total flexible volume clone hierarchy comprising the flexible volume 610 and the flexible volume clone 620 will comprise a total of 11 terabytes of storage space at storage site B. However, if the flexible volume clone hierarchy is not retained at storage site B at the conclusion of the migration of flexible volume 610 and flexible volume clone 620, then flexible volume clone hierarchy may be effectively flattened and the total storage space utilization may comprise 10 terabytes for the migrated flexible volume 610 at storage site B, an additional 10 terabytes for the flexible volume clone 620 image of the flexible volume 610, and an additional 1 terabyte of storage space for the delta flexible volume portion of the flexible volume clone 620 for a total storage overhead of 21 terabytes. As such, the retention of the flexible volume clone hierarchy during the migration of the flexible volume 610 and the flexible volume clone 620 comprises lower storage overhead at storage site B as well as providing rollback and rapid retry and rollback options as described in further detail below.

As seen in FIG. 6, a conceptual operation of a migration method 600 that may be implemented in a cluster storage environment is illustrated. The migration method 600 may be performed by data clone migration manager 310 and operating systems residing and executing on each storage system 120 that operate in conjunction to migrate storage data from a current site (e.g., storage site A) to a new storage site (e.g., storage site B). As used herein, “data clone migration manager” 310 may reside and execute on a storage site (e.g., storage site A) that comprises a flexible volume clone hierarchy to be migrated to a second storage site (e.g., storage site B). When performing the migration method, the data clone migration manager 310 may generate, use, or store data in a data clone hierarchy migration management data structure 450 stored to memory 428. In some embodiments, the data clone hierarchy migration management data structure 450 resides within the storage site A from which the migration is being performed. In the same or alternative embodiment, the data clone hierarchy migration management data structure 450 resides within the storage site B from which the flexible volume clone hierarchy is being migrated and stored. In some embodiments, the data clone hierarchy migration management data structure 450 may reside or execute from within both storage site A and storage site B during the migration process. As discussed below, such data may include data or log information with regard to the flexible volume clone hierarchy.

FIG. 6 illustrates the start of the migration method whereby the data clone hierarchy migration management data structure 450 is within the storage site A. In some embodiments, the data clone hierarchy migration management data structure 450 of storage site A generates an image 640 of the base flexible volume 610. In some embodiments, the image 640 is then transmitted, at link 650, to the storage system 120 comprised within storage site B. The base flexible volume 610 is then provisioned to at least one storage device 130 at the storage site B. In some embodiments, the base flexible volume may comprise a plurality of RAID disks as described with regard to FIG. 5. As such, the base flexible volume 610 is provisioned on the destination storage site (e.g., storage site B). Next, the method 600 may transfer or provision any flexible volume clones related to the base flexible volume 610. For example, the flexible volume clone 620 may be provisioned on the destination storage site (e.g., storage site B). As described above, the flexible volume clone 620 may comprise a writable point-in-time image of the flexible volume 610 and as such comprise a delta flexible volume clone portion that comprises a difference between the flexible volume clone 620 and the base flexible volume 610. As such, the flexible volume clone 620 may be provisioned onto the destination storage site (e.g., storage site B).

In some embodiments, a flexible clone volume may comprise a pointer to an image of a base flexible volume and a delta data that may comprise data changes or new data made at the time of the creation of the image of the base flexible volume and the creation of the clone. For example, data changes may be made after a first time instance when an image of the base flexible volume is created. At a second time instance, a clone of the base flexible volume may be created. As such, in some embodiments, the delta data may comprise any changed data or new data from the time of the creation of the image of the base flexible volume to the creation of the clone of the base flexible volume. In some embodiments, the delta data may comprise data changes or new data made at the time of the creation of the clone and a point at the migration process. For example, the delta data may comprise any changed data or new data from the time of the creation of the clone of the base flexible volume and an initiation of the migration process.

In some embodiments, a flexible volume clone may be derived from another flexible volume clone. As such, if a user or administrator is migrating a flexible volume clone hierarchy from a source storage site to a destination storage site, a plurality of flexible volume clones may be migrated or provisioned on the storage devices of the destination storage site. For example, an embodiment may comprise a base flexible volume. A first flexible volume clone may be derived from the base flexible volume. As such, the first flexible volume clone comprises a writable point-in-time image of the base flexible volume. In addition, a second flexible volume clone may be derived from the first flexible volume clone. As such, the second flexible volume clone comprises a writable point-in-time image of the first flexible volume. As a result, the flexible volume clone hierarchy comprises a base flexible volume, a first flexible volume clone, and a second flexible volume clone. The migration of the flexible volume hierarchy may comprise provisioning each of the base flexible volume, first flexible volume clone, and the second flexible volume clone onto the destination storage site as well as maintaining the hierarchical structure between each of the base flexible volume, first flexible volume clone, and second flexible volume clone. Details on this migration process are discussed in further detail below.

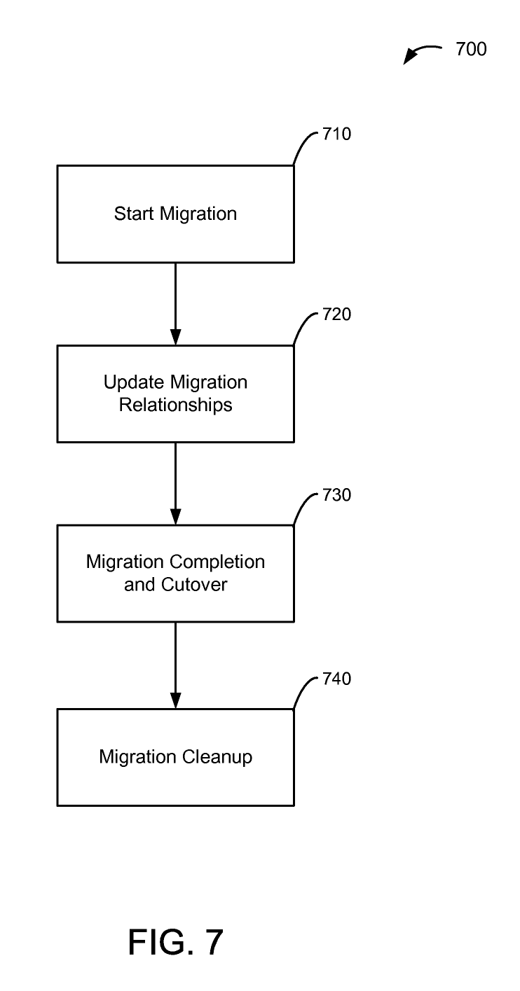

FIG. 7 is a flowchart of a method 700 for the migration of a flexible volume clone hierarchy from a first storage site to a second storage site in accordance with some embodiments. The method 700 of FIG. 7 is described in relation to FIG. 6 which conceptually illustrates the steps of the method 700. In some embodiments, the method 700 may receive information about flexible volumes, flexible volume clones and the related hierarchy between the various flexible volumes and flexible volume clones, provision flexible volumes or flexible volume clones onto a destination storage site, and transfer data while retaining the flexible volume clone hierarchy from a source storage site to a second storage site automatically, without human initiation, interaction, or intervention. In some embodiments, particular steps of the method 700 may be performed automatically, without human initiation, interaction, or invention, while other steps of the method 700 may be performed with human interaction. For example, in some embodiments, steps 720, 730, and 740 may be performed automatically, without human initiation, interaction, or intervention, while steps 710 may be performed by human interaction, such as commands from an administrator.

In some embodiments, some of the steps of method 700 are performed or caused to be performed by a data clone migration manager 410 on a management server 305. The data clone migration manager 410 may be configured to operate in conjunction with other software modules of the management server 305, server system 110, and software modules of the storage system 100 to collectively perform the embodiments described herein.

The method 700 begins by starting (at step 710) the migration process of the flexible volume clone hierarchy. The migration process may include a baseline transfer of data from a source storage site (e.g., storage site A) to a destination storage site (e.g., storage site B). As described above, the transferred data may comprise data from base flexible volumes and/or flexible volume clones. Moreover, the transfer may comprise retaining the hierarchical relationship between the base flexible volumes and flexible volume clones. In some embodiments, the start of the migration (at step 710) may utilize the NetApp® SnapMirror® Async technology to replicate or perform the baseline transfer of the data from the source storage site to the destination storage site. Further details with regard to the migration of the data comprising base flexible volumes and/or flexible volume clones from the source storage site to the destination storage site are described in detail below.

The method 700 may update (at step 720) the migration relationships between the source storage site and the destination storage site. For example, in some embodiments, the start (at step 710) of the migration process may comprise a long running time such that changes may have been performed on the base flexible volume or the flexible volume clone. In some embodiments, the time to perform the baseline transfer may take days, weeks, or months depending on the amount of data to be transferred. As such, the start of the migration process involving the baseline transfer of data from the source storage site to the destination storage site may take a significant amount of time and during this period, changes may be performed to the migrated data. For example, a user or administrator may change data comprised within the base flexible volume or the delta flexible volume clone portion of a flexible volume clone. As such, at step 720, the method 700 may update the relationships between the data on the source storage site and the destination storage site by updating the data that has been migrated to the destination storage site such that it mirrors the changed data on the source storage site. As such, in some embodiments, the step 720 may comprise an update of SnapMirror® relationships.

For example, in some embodiments, a source storage site may comprise a base flexible volume and a flexible volume clone. As discussed above, the flexible volume clone may comprise a writable point-in-time image of a base flexible volume and as such comprise a delta flexible volume clone portion that comprises data of a difference between the flexible volume clone and the base flexible volume. At step 710, a user or administrator may begin the process to migrate data from a source storage site to a destination storage site. During the migration process, a user or administrator may change the delta flexible volume clone portion that comprises a difference between the flexible volume clone and the base flexible volume. As such, at step 720, the delta data of the flexible volume clone that has been provisioned to the destination storage site may be updated such that the flexible volume clone that has been provisioned to the destination storage site comprises an identical delta flexible volume clone portion as the flexible volume clone that has been provisioned on the source storage site.

The step 720 may, in some embodiments, be performed automatically, without human initiation, interaction, or intervention. In other embodiments, the step 720 may be performed by human interaction, such as operations by an administrator.

The method 700 may complete the migration (at step 730) and perform a migration cutover operation. In some embodiments, the cutover operation occurs when the migration of the data (e.g., the flexible volume clone hierarchy) from the source storage site to the destination storage site has completed. The cutover operation may comprise the migrated data on the destination storage site coming online and thus serving the data from the destination storage site in response to data requests. For example, a user or administrator may perform a migration of a base flexible volume and a flexible volume clone from a source storage site to a destination storage site. The base flexible volume and the flexible volume clone may be provisioned on the destination storage site. However, the provisioned base flexible volume and the flexible volume clone may not be online and serving data in response to data requests until the migration cutover operation is completed. Once the migration cutover (e.g., at step 730) is performed and completed, then the provisioned base flexible volume and the flexible volume clone on the destination storage site may be online and thus respond to and serve data from the provisioned base flexible volume and flexible volume clone in response to data requests.

The step 730 may, in some embodiments, be performed automatically, without human initiation, interaction, or intervention. In other embodiments, the step 730 may be performed by human interaction, such as operations by an administrator.

The method 700 may perform (at step 740) a migration cleanup operation. In some embodiments, the migration cleanup may comprise deleting or removing the migrated data from the source storage site. For example, if a user or administrator has migrated a base flexible volume and a flexible volume clone from the source storage site to a destination storage site, the migration cleanup operation may remove the base flexible volume and the flexible volume clone from the source storage site. As such, the migrated data may be removed from the source storage site. In some embodiments, the migration cleanup operation may further perform network cleanup operations. For example, the migration cleanup operation may comprise deleting unneeded ipspaces and vlans.

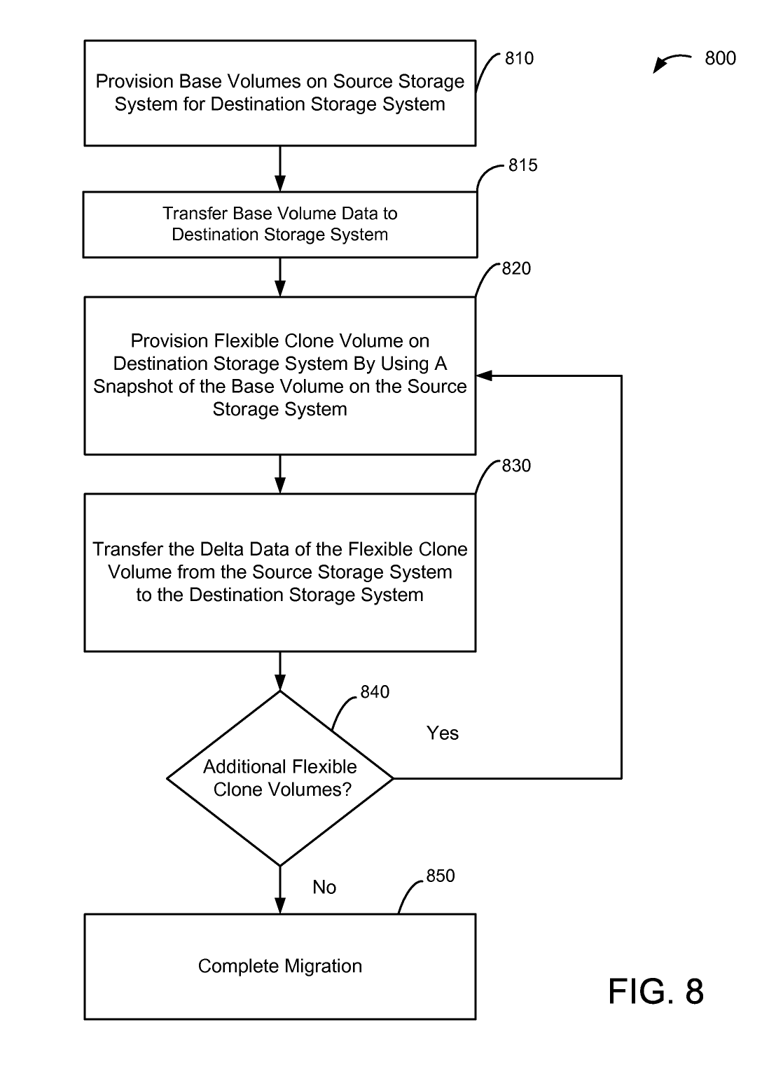

FIG. 8 is a flowchart of a method 800 for the provisioning of a flexible volume clone hierarchy from a first storage site to a second storage site in accordance with some embodiments. In some embodiments, a flexible volume clone hierarchy may comprise a base flexible volume, a first flexible volume clone of the base flexible volume, and a second flexible volume clone of the first flexible volume clone. The method 800 may (at step 810) provision the base flexible volume on a destination storage site. Following the provisioning of the base flexible volume onto the destination storage site, a baseline transfer (at step 815) of the provisioned base flexible volume may occur. As such, a replication of the storage content of the base flexible volume is performed on the provisioned volume within the destination storage site.

The method 800 may then provision (at step 820) the first flexible volume clone using a snapshot of the previously provisioned base flexible volume. As such, the provisioned first flexible volume clone comprises a writeable point-in-time image of the base flexible volume. The method 800 may transfer or resynchronize (at step 830) the delta flexible volume portion of the first flexible volume clone from the source storage site to the second storage site. A determination may be made (at step 840) whether additional flexible clone volumes need to be provisioned and/or transferred from the source storage site to the second storage site. For example, since the flexible clone hierarchy may comprise a second flexible volume clone (e.g., a clone of the first flexible volume clone), then the second flexible volume clone may be provisioned onto the destination storage site. However, the provisioning of the second flexible volume clone may comprise a snapshot of the first flexible volume clone. The method 800, after provisioning the second flexible volume clone, may then transfer the delta flexible volume clone portion to the destination storage site.

As such, the method 800 comprises a continuous process until all flexible volume clones of the flexible volume hierarchy are provisioned onto a destination storage site and their data is transferred to the destination storage site.

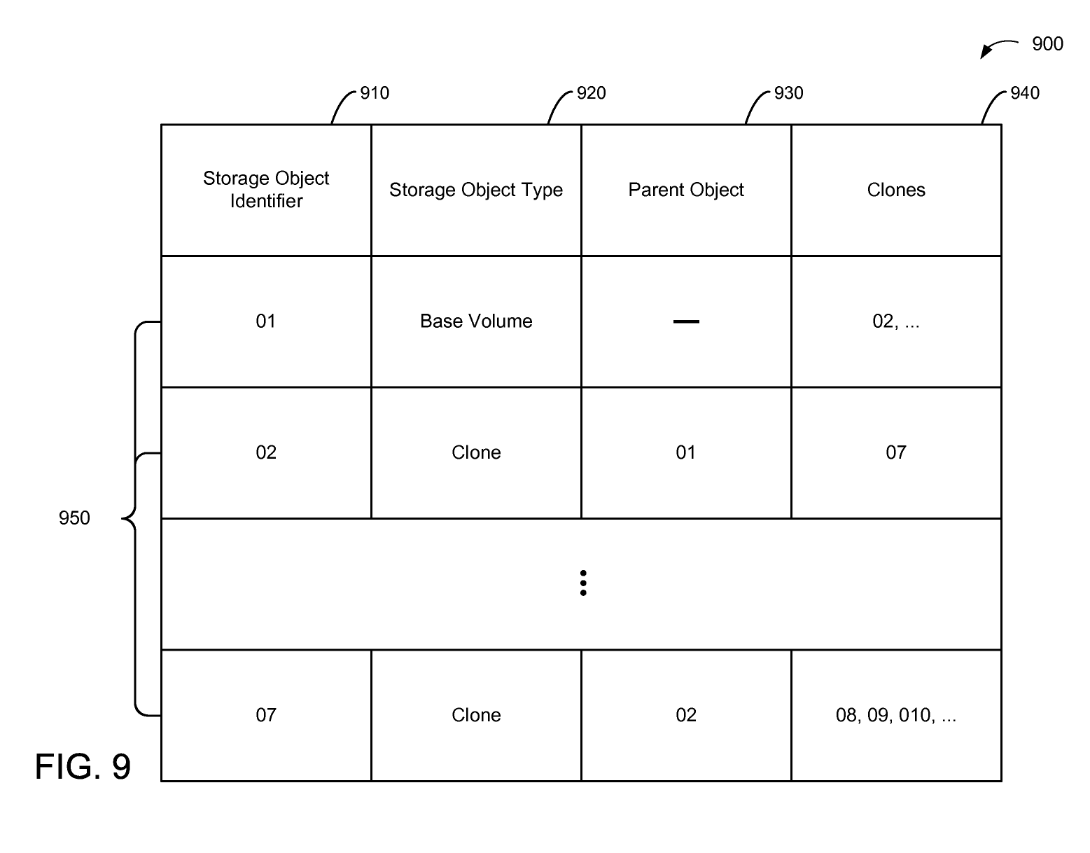

FIG. 9 shows an exemplary data clone hierarchy migration management data structure 900 used in some embodiments. In some embodiments, data clone hierarchy migration management data structure 900 comprises a plurality of dataset entries 950, each dataset entry 950 representing a flexible volume identifier, flexible volume type, parent volume, and clone volumes (discussed below). Each entry 950 may comprise a plurality of data fields for storing data describing or identifying the flexible volumes, base flexible volume, and flexible volume clones.

In some embodiments, a data clone hierarchy migration management data structure entry 950 representing a flexible volume may contain data fields for a flexible volume identifier 910, flexible volume type identifier 920, base flexible volume identifier 930, and flexible volume clone identifier 940. The flexible volume identifier 910 may comprise information identifying a specific flexible volume. For example, the flexible volume identifier 910 may comprise a name or address of a flexible volume. In some embodiments, the flexible volume identifier may identify a base flexible volume or the flexible volume identifier may provide identity information for a flexible volume clone. As such, the flexible volume identifier 910 may identify either of a base flexible volume or a flexible volume clone.

The flexible volume type 920 may specify the type of flexible volume for each data clone hierarchy migration management data structure entry field. For example, the flexible volume type 920 may specify whether a flexible volume is a base flexible volume or whether the flexible volume is a flexible volume clone. Base flexible volume 930 may identify whether each data clone hierarchy migration management data structure entry is based or derived from a base flexible volume. For example, if a flexible volume is a base flexible volume, and as such is not based off of another flexible volume (e.g., the base flexible volume is not a clone), then the base flexible volume 930 may indicate that there is no base flexible volume. However, if the flexible volume is a flexible volume clone, then the base flexible volume may identify the flexible volume clone's base flexible volume.

For example, the base flexible volume 930 may indicate that a particular flexible volume clone comprises a base flexible volume. However, in some embodiments, a first flexible volume clone may comprise the base flexible volume for a second flexible volume clone. As such the base flexible volume 930 may indicate that a flexible volume clone is based or derived from another flexible volume clone. Flexible volume clone 940 may indicate whether the flexible volume from each data clone hierarchy migration management data structure entry has any flexible volume clones that are based upon it. For example, a base flexible volume may be used for a plurality of flexible volume clones. As such, the flexible volume clone 940 may indicate each of the flexible volume clones that are based off of the base flexible volume.

In some embodiments, the flexible volume identifier field 910, flexible volume type field 920, base flexible volume field 930, and flexible volume clone field 940 may be generated or received when any base flexible volume or flexible volume clone is provisioned on a source storage site. For example, the data clone hierarchy migration management data structure 900 may be updated whenever a flexible volume is provisioned. In some embodiments, the data clone hierarchy migration management data structure 900 is updated or generated when a data migration of data from a source storage site to a destination storage site is initiated.

As such, the data clone hierarchy migration management data structure 900 receives information about flexible volumes, stores the information about the flexible volumes in a data structure, and comprises a hierarchical relationship between the flexible volumes.

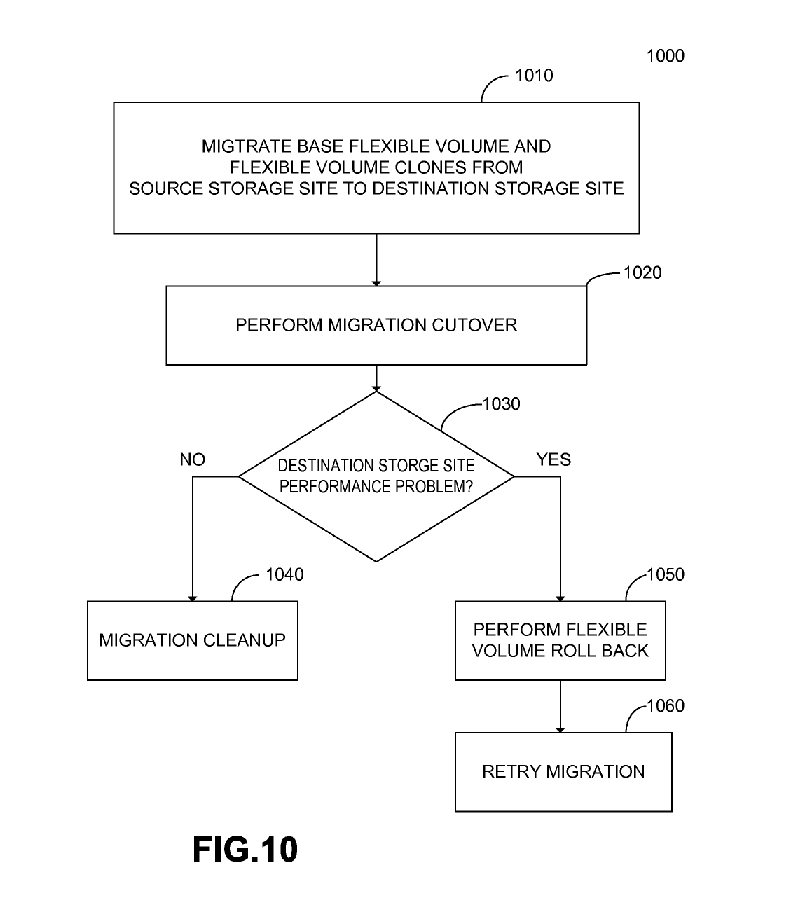

FIG. 10 is a flowchart of a method 1000 for the migrating of a flexible volume clone hierarchy from a source storage site to a destination storage site and a rollback and retry of the migration. The method 1000 may (at step 1010) migrate the base flexible volume and the flexible volume clone data from the source storage site to the destination storage site as previously described. The method 1000 may (at step 1020) then perform a migration cutover of the base flexible volume and the flexible volume clone such that the data services of such flexible volumes on the destination storage site are now being served to application requests. At step 1030, the method 1000 may make a determination of whether the destination storage site performance is subpar. For example, the application requests may not be served as quickly, As such, the destination storage site comprises a memory space or performance issue. If the destination storage site does not comprise a memory or space issue, then the method 1000 may (at step 1040) perform a migration cleanup. However, if the destination storage site does comprise a memory or space issue, then the method 1000 may (at step 1050) perform a flexible roll back. For example, the flexible volume clone hierarchy may be removed from the destination storage site and the flexible volume clone hierarchy may be restored at the source storage site. As such, a base flexible volume and a flexible clone volume of the base flexible volume and its dependent status may be retained in the rollback. The method 1000 may then (at step 1060) retry the migration of the flexible volume clone hierarchy from the source storage site to the destination storage site.

### VARIOUS EMBODIMENTS

Some embodiments may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information may be represented using any of a variety of different technologies and techniques.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a non-transitory computer readable medium. The computer readable medium may comprise a storage medium having instructions stored thereon/in which may be used to control, or cause, a computer to perform any of the processes of an embodiment. The storage medium may include, without limitation, any type of device including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Those of skill would further appreciate that the various illustrative logical blocks, circuits, modules, algorithms, techniques, processes, or method steps of embodiments described herein may be implemented as computer electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The algorithm, techniques, processes, or methods described in connection with embodiments disclosed herein may be embodied directly in hardware, in software executed by a processor, or in a combination of the two. In some embodiments, any software application, program, tool, module, or layer described herein may comprise an engine comprising hardware and/or software configured to perform embodiments described herein. In general, functions of a software application, program, tool, module, or layer described herein may be embodied directly in hardware, or embodied as software executed by a processor, or embodied as a combination of the two. A software application, layer, or module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

What is claimed is:

1. A system for migrating data on a source storage system to a destination storage system, the source storage system providing data storage to at least one storage object, the system comprising:
a data clone migration manager engine configured for:
receiving hierarchical storage object data describing a relationship between a first source storage object and a first clone of the first source storage object, the hierarchical storage object data indicating that the first clone is derived from the first source storage object and comprises a pointer to an image of the first source storage object, the first source storage object and the first clone being stored in the source storage system;
provisioning a first destination storage object on the destination storage system;
transferring data of the first source storage object on the source storage system to the first destination storage object on the destination storage system, the transferring comprising the writing of the data of the first source storage object on the source storage system to at least one storage device of the destination storage system;
provisioning a second destination storage object on the destination storage system; and
configuring the second destination storage object to store a pointer to the data of the first destination storage object on the destination storage system.

2. The system of claim 1, wherein:
the image of the first source storage object is produced at a first time point and the first clone is produced at a second time point after the first time point;
a delta data of the first clone comprises changes to the first source storage object between the first time point when the first image is generated and the second time point when the first clone is produced, the delta data being stored in the source storage system; and
the data clone migration manager engine is further configured for:
transferring the delta data of the first clone from the source storage system to the second destination storage object on the destination storage system.

3. The system of claim 1, wherein each of the storage objects are comprised within a storage aggregate, the storage aggregate is abstracted over a Redundant Array of Independent Disks (RAID) plex, each RAID plex comprises a RAID group that comprises a plurality of storage disks.

4. The system of claim 1, wherein the storage object comprises a flexible volume, the flexible volume comprises data distributed over a plurality of storage devices.

5. The system of claim 1, wherein the hierarchical storage object data comprises a storage object type, parent object, and derived clones of the first source storage object and the first clone, the storage object type specifies whether the storage object comprises a base storage object or a clone storage object, the parent object specifies the storage object that the clone of the first source storage object is derived, the derived clones specify clones derived from the first source storage object and the first clone.

6. The system of claim 2, wherein:
the hierarchical storage object data further describes a relationship between the first clone and a second clone comprising a clone of the first clone, the hierarchical storage object data indicating that the second clone is derived from the first clone and comprises a pointer to an image of the first clone, the second clone being stored in the source storage system; and
the data clone migration manager engine is further configured for:
provisioning a third destination storage object on the destination storage system; and
configuring the third destination storage object to store a pointer to the image of the first clone on the destination storage system.

7. The system of claim 1, the data clone migration manager engine is further configured for:
performing a roll back of the first destination storage object on the destination storage system and the second destination storage object on the destination storage system, the roll back comprising a removal of the first destination storage object and the second destination storage object on the destination storage system and a restoration of the first source storage object and the first clone on the source storage system, the relationship between the first source storage object and the first clone is retained on the source storage system.

8. A non-transitory computer readable medium having instructions stored thereon when executed by a processor, migrates data on a source storage system to a destination storage system, the source storage system providing data storage to at least one storage object, the computer readable medium comprising sets of instructions for:
receiving hierarchical storage object data describing a relationship between a first source storage object and a first clone of the first source storage object, the hierarchical storage object data indicating that the first clone is derived from the first source storage object and comprises a pointer to an image of the first source storage object, the first source storage object and the first clone being stored in the source storage system;
provisioning a first destination storage object on the destination storage system;
transferring data of the first source storage object on the source storage system to the first destination storage object on the destination storage system, the transferring comprising the writing of the data of the first source storage object on the source storage system to at least one storage device of the destination storage system;
provisioning a second destination storage object on the destination storage system; and
configuring the second destination storage object to store a pointer to the data of the first destination storage object on the destination storage system.

9. The non-transitory computer readable medium of claim 8, wherein the image of the first source storage object is produced at a first time point and the first clone is produced at a second time point after the first time point, a delta data of the first clone comprises changes to the first source storage object between the first time point when the first image is generated and the second time point when the first clone is produced, the delta data being stored in the source storage system, the computer readable medium further comprising sets of instructions for:
transferring the delta data of the first clone from the source storage system to the second destination storage object on the destination storage system.

10. The non-transitory computer readable medium of claim 8, wherein each of the storage objects are comprised within a storage aggregate, the storage aggregate is abstracted over a Redundant Array of Independent Disks (RAID) plex, each RAID plex comprises a RAID group that comprises a plurality of storage disks.

11. The non-transitory computer readable medium of claim 8, wherein the storage object comprises a flexible volume, the flexible volume comprises data distributed over a plurality of storage devices.

12. The non-transitory computer readable medium of claim 8, wherein the hierarchical storage object data comprises a storage object type, parent object, and derived clones of the first source storage object and the first clone, the storage object type specifies whether the storage object comprises a base storage object or a clone storage object, the parent object specifies the storage object that the clone of the first source storage object is derived, the derived clones specify clones derived from the first source storage object and the first clone.

13. The non-transitory computer readable medium of claim 9, wherein the hierarchical storage object data further describes a relationship between the first clone and a second clone comprising a clone of the first clone, the hierarchical storage object data indicating that the second clone is derived from the first clone and comprises a pointer to an image of the first clone, the second clone being stored in the source storage system, the computer readable medium further comprising sets of instructions for:
provisioning a third destination storage object on the destination storage system; and
configuring the third destination storage object to store a pointer to the image of the first clone on the destination storage system.

14. The non-transitory computer readable medium of claim 8, further comprising sets of instructions for:
performing a roll back of the first destination storage object on the destination storage system and the second destination storage object on the destination storage system, the roll back comprising a removal of the first destination storage object and the second destination storage object on the destination storage system and a restoration of the first source storage object and the first clone on the source storage system, the relationship between the first source storage object and the first clone is retained on the source storage system.

15. A method for migrating data on a source storage system to a destination storage system, the source storage system providing data services for a plurality of applications, the data services comprising at least one underlying storage object, the method comprising:
using computer hardware for performing:
receiving hierarchical storage object data describing a relationship between a first source storage object and a first clone of the first source storage object, the hierarchical storage object data indicating that the first clone is derived from the first source storage object and comprises a pointer to an image of the first source storage object, the first source storage object and the first clone being stored in the source storage system;
provisioning a first destination storage object on the destination storage system;
transferring data of the first source storage object on the source storage system to the first destination storage object on the destination storage system, the transferring comprising the writing of the data of the first source storage object on the source storage system to at least one storage device of the destination storage system;
provisioning a second destination storage object on the destination storage system; and
configuring the second destination storage object to store a pointer to the data of the first destination storage object on the destination storage system.

16. The method of claim 15, the method further comprising:
the image of the first source storage object is produced at a first time point and the first clone is produced at a second time point after the first time point;
a delta data of the first clone comprises changes to the first source storage object between the first time point when the first image is generated and the second time point when the first clone is produced, the delta data being stored in the source storage system; and
transferring the delta data of the first clone from the source storage system to the second destination storage object on the destination storage system.

17. The method of claim 15, wherein each of the storage objects are comprised within a storage aggregate, the storage aggregate is abstracted over a Redundant Array of Independent Disks (RAID) plex, each RAID plex comprises a RAID group that comprises a plurality of storage disks.

18. The method of claim 15, wherein the storage object comprises a flexible volume, the flexible volume comprises data distributed over a plurality of storage devices.

19. The method of claim 15, wherein the hierarchical storage object data comprises a storage object type, parent object, and derived clones of the first source storage object and the first clone, the storage object type specifies whether the storage object comprises a base storage object or a clone storage object, the parent object specifies the storage object that the clone of the first source storage object is derived, the derived clones specify clones derived from the first source storage object and the first clone.

20. The method of claim 16, wherein the hierarchical storage object data further describes a relationship between the first clone and a second clone comprising a clone of the first clone, the hierarchical storage object data indicating that the second clone is derived from the first clone and comprises a pointer to an image of the first clone, the second clone being stored in the source storage system, the method further comprising:
provisioning a third destination storage object on the destination storage system; and
configuring the third destination storage object to store a pointer to the image of the first clone on the destination storage system.
